(19) United States
(12) Patent Application Publication
(10) Pub. No.: US 2014/0295678 A1
(43) Pub. Date: Oct. 2, 2014

(54) CONTROLS

(71) Applicant: Vincent Joseph Garvey, Colby (GB)

(72) Inventor: Vincent Joseph Garvey, Colby (GB)

(73) Assignee: Strix Limited, Ronaldsway, Isle of Man (GB)

(21) Appl. No.: 14/238,113

(22) PCT Filed: Aug. 10, 2012
(86) PCT No.: PCT/GB2012/051957

§ 371 Date: Jun. 6, 2014

(30) Foreign Application Priority Data
Aug. 10, 2011 (GB) 1113780.9
Mar. 6, 2012 (GB) 1203957.4

(51) Int. Cl. H01R 24/38

(52) U.S. Cl. CPC H01R 24/38
USPC 439/11; 29/876

(57) ABSTRACT

A connector part is provided for supplying power to an independent appliance part in a cordless electrical appliance. The connector part is of the type that makes an electrical connection between the electrical terminations of the appliance connector part and corresponding electrical contacts in the connector part when the independent connector parts are brought together, irrespective or substantially irrespective of their relative angular orientation. The connector part comprises a sub-assembly in which the electrical contacts are permanently attached to respective conductors in a mains power supply cable. The point of permanent attachment may be protected by a plastics overmolding.

This application is entitled to the benefit of, and incorporates by reference essential subject matter disclosed in PCT Application No. PCT/GB2012/051957 filed on Aug. 10, 2012, which claims priority to GB1113780.9 filed Aug. 10, 2011 and GB1203957.4 filed Mar. 6, 2012.

### BACKGROUND OF THE INVENTION

1. Technical Field

This invention relates to cordless electrical connectors for cordless electrical appliances such as liquid heating apparatus.

2. Background Information

These days a liquid heating apparatus such as an electric kettle is often of the cordless type, comprising a base for connection to the mains supply and a removable cordless appliance that mates with the base to receive power therefrom. Many cordless electrical appliances comprise a so-called 360° connector, that is, an appliance connector part that can be brought into engagement with a corresponding base connector part provided by a power base unit regardless of the relative angular orientation of the two parts. The cordless connector may include two or three electrical terminals (e.g. live, neutral and optionally earth) for basic power connection, such as the Strix P72, or a larger number of terminals for additional electrical/data connections, such as the Strix Pb76. Examples of cordless connector systems are described in the Applicant's published applications WO 95/08204 and WO 01/28294. In particular, the appliance connector part may be in the form of a male connector part comprising one or more annular terminals and the base connector part may be in the form of a female connector part comprising one or more corresponding annular recesses.

In addition to the cordless connector, an electric kettle or hot water jug is typically equipped with a control, electrically connected to an electric heating element in the base of the vessel. The control may operate, when liquid in the vessel boils, to disconnect the power supply to the heater via the cordless connector and so too discontinue boiling. Similarly the control can provide an overheat function which disconnects the power supply when the heater exceeds a safe operating temperature.

In a typical cordless connector system there are two sets of silver-coated or silver-tipped contacts, one set of contacts provided between the control and the electrical terminals of the appliance connector part, and another set of contacts in the base connector part. Copper alloy leaf springs are commonly employed as moveable mounts for contacts which make or break the electrical power circuit of the cordless connector, with the leaf springs carrying current as part of the circuit. Typically the leaf springs in the control are acted on via a push-rod by a thermally sensitive bimetallic actuator which operates when the liquid in the vessel boils or the heater overheats. The contacts in the base connector part are typically mounted on leaf springs so that they resiliently mate with the terminals of the male appliance connector part when the two parts are engaged.

It is an object of the present invention to provide improvements in cordless connectors and in cordless electrical appliances.

### SUMMARY OF THE DISCLOSURE

When viewed from a first aspect the present invention provides a cordless electrical appliance comprising an appliance unit separable from a base unit which supplies electrical power to the appliance unit when it is placed thereon by means of a cordless electrical connector, said connector being of the type which allows placement of the appliance unit on the base unit irrespective, or substantially irrespective, of their relative angular orientation, the cordless connector comprising a connector part in the appliance unit with electrical terminals that can be brought into engagement with a corresponding connector part in the base unit to make an electrical connection to electrical contacts therein, wherein the base connector part is integrated with a power supply cable and the contacts are connected to conductors in the power supply cable, the power supply cable and the base connector part being integrally molded as a single plastic or plastics part that houses the contacts.

It will be appreciated that integrally molding the power supply cable with the base connector part, or at least a main part of that connector, can reduce the number of molding operations required during manufacture and make the electrical connections more robust with the protection provided by the molded plastic part. Assembly of the power base unit may also be simplified as the single plastic molded part can be fitted to the base unit without the need for any separate fasteners for the power supply cable. The integrally molded part can conveniently be snap fitted to the base unit in a single assembly step. Any further components of the base connector part, such as a cover or the like, may also be attached to the main molded part, e.g. with a snap-fit. A cover can provide a safety feature, preventing access to the (exposed) live parts.

The cordless electrical appliance is preferably a liquid heating apparatus comprising an electric heating element connected to the cordless electrical connector. The cordless electrical connector may interact with, or be provided as part of, a control for the heating element. In particular the connector part on the appliance part need not be a separate or distinct component but may simply comprise those parts of a control which make electrical connection with the contacts in the base connector part. Indeed it is specifically envisaged that the electrical terminals in the appliance may be moveable so as to be able to form a switching arrangement with fixed contacts in the base connector part.

The electric heating element will typically be arranged in good thermal contact with the liquid to be heated in the apparatus. The electric heating element could comprise a sheathed heating element, e.g. immersed or mounted on the underside of a heater plate in the base of the liquid heating apparatus (a so-called underfloor heater), or a thick film heating element.

It will be understood that the advantages discussed above do not rely on the nature of the appliance itself. The invention therefore extends to a base connector part for supplying power to an independent appliance part in a cordless electrical appliance, the connector parts being separable such that an electrical connection between the electrical terminations of the appliance connector part and corresponding electrical contacts in the base connector part is made when the independent connector parts are brought together, irrespective or substantially irrespective of their relative angular orientation, wherein the base connector part is integrated with a power supply cable, the electrical contacts in the connector part being connected to conductors in the power supply cable, and the power supply cable and the base connector part being integrally molded as a single plastic or plastics part that houses the contacts.

The base connector part is of the type which allows electrical connection to be made substantially irrespective of the relative angular orientation between it and the control—i.e. a so-called 360° connector. However in some embodiments the connector may not allow full 360° relative to the orientation of the appliance part, but while still allowing electrical connection to be made substantially irrespective of this orientation, e.g. through a range of 345° or greater.

It will be further appreciated that integrating the base connector part with a power supply cable can not only make the electrical connections in the appliance more robust, but also potentially provide a material saving by reducing the number of separate parts comprised in the power base unit. Instead of the electrical contacts in the base connector part being mounted on separate leaf springs which are themselves connected to the power supply cable for the base unit, as is conventional, the contacts may each be provided by a surface of a contact member that is directly connected to the conductors in the power supply cable. Such connection can be protected by an integral molding with the power supply cable. Thus in one set of embodiments each electrical contact comprises an integral contact member having a contact surface and a body connected to a conductor in the power supply cable.

When the base connector part is integrally molded with the power supply cable it may be possible for the electrical contacts to connect to the conductors in the power supply cable via conventional leaf springs, but this would likely complicate the molding as it would have to be formed with internal spaces to accommodate the movement of the contacts when mounted on leaf springs. Therefore, it is further preferred that the contacts, or rather the body of the contact members, have a static connection with the conductors in the power supply cable. Such a static connection may be encapsulated by the plastic molding without interfering with the operation of the connector, i.e. switching current at the contact surface, and with the benefit of making the connection more durable. Elimination of moving parts such as leaf springs can reduce the number of parts and improve reliability, as well as saving material costs. A simple spade terminal or blade (“Faston”) connector may be used instead. However, these benefits may be amplified by eliminating any intermediate connector and thus in a further preferred set of embodiments the contacts, or rather the body of the contact members, are directly connected with the conductors in the power supply cable. The integrity of the electrical connections in the base unit is thereby further improved.

The direct connection of the electrical contacts to the conductors of the power supply cable preferably comprises a permanent attachment. A permanent attachment may be protected by part of the integral molding. For example, the electrical contacts may comprise a contact member that is mechanically attached to the terminal ends of the conductors and then at least partly encapsulated by the integral molding to protect the point of attachment while the contact surface remains exposed. The Applicant has recognized that a benefit of a permanent attachment between the conductors of a power supply cable and the electrical contacts of a base connector part is that the cable and contacts can be provided together as an integrated sub-assembly. Such a sub-assembly may then be used to manufacture a range of different connectors, for example for different cordless appliances.

This feature is considered novel and inventive in its own right, regardless of whether the power supply cable and the base connector part are integrally molded, and thus when viewed from a second aspect the present invention provides a sub-assembly comprising a mains power supply cable and electrical contacts for a connector part for supplying power to an independent appliance part in a cordless electrical appliance, the connector parts being separable such that an electrical connection between the electrical terminations of the appliance connector part and the corresponding electrical contacts in the connector part is made when the independent connector parts are brought together, irrespective or substantially irrespective of their relative angular orientation, wherein in the sub-assembly the electrical contacts are permanently attached to respective conductors in the mains power supply cable.

Integration of a sub-assembly for a connector part is advantageous as it recognizes that the same connector part may not be employed in appliances intended for use in different countries due to the differences in the mains electrical power supply. For example, the mains supply in Europe is generally 230 V and in China it is 220 V, while in the USA it is only 120 V and in Japan only 100 V. A connector in a liquid heating appliance rated for use in the USA or Japan will switch a much larger current for the same power output than one rated for use in China or Europe. A 1500 W appliance in Japan draws a current of 15 A compared to only 6.5 A for the same power output in China. The electrical contacts in the connector part can be optimally designed for the current, for instance the thickness of a layer of silver on one or more of the contact surfaces may be selected to minimize the amount of silver required while also ensuring that the connector is safe for use with the intended electrical power supply and expected current. An integrated sub-assembly comprising the electrical contacts permanently attached to the conductors of a mains power supply cable can ensure that the contacts are matched to the current drawn from the power supply regardless of the design of the rest of the connector or further manufacturing steps involved.

This aspect of the invention extends to a connector part for supplying power to an independent appliance part in a cordless electrical appliance, the connector parts being separable such that an electrical connection between the electrical terminations of the appliance connector part and corresponding electrical contacts in the connector part is made when the independent connector parts are brought together, irrespective or substantially irrespective of their relative angular orientation, wherein the connector part comprises a sub-assembly comprising a mains power supply cable and the electrical contacts, in which the electrical contacts are permanently attached to respective conductors in the mains power supply cable. In another aspect the invention also extends to a method of manufacturing such a connector part.

It will be appreciated that such a sub-assembly provides a new approach to making cordless connectors for mains electrical power supply. Previously a cordless connector, or at least the base connector part thereof, would be manufactured as a generic item that is then attached to a mains power supply cable rated for the expected current when used in a particular country. Typically a spade terminal, crimp-on connector or “Faston” tab connector is used to removably attach leaf springs carrying the electrical contacts in the base connector part to the conductors in the mains power supply cable. However, this approach requires the electrical contacts in the connector to be over-designed for many applications just so that they can safely switch high currents e.g. in appliances connected to the Japanese or US mains power supply. Otherwise there is a risk that the electrical contacts designed for use with one power supply cable e.g. 6.5 A might be assembled with a power supply cable rated for 15 A when they are not within safety limits for switching higher currents. By integrating the mains power supply cable with the electrical contacts in a sub-assembly before assembling the connector part, the material(s) used for the electrical contacts, or at least the contact surface thereof, can be matched to the current to be supplied via the mains power cable. The mains power supply cable may be rated for a voltage of at least 90 V, and preferably up to 100 V, 110 V, 120 V, 220 V, 230 V, 240 V or 250 V. Such voltage ratings are much higher than for cables supplying power to appliances containing batteries, such as e.g. mobile phones, laptops, etc. However the current supplied by such a cable will still depend on the power output of the appliance and it is advantageous for the connector of a cordless appliance to be matched to the current to be supplied.

As is described above, preferably each electrical contact comprises an integral contact member having a contact surface and a body that is permanently attached to a conductor in the power supply cable. The attachment point may, for example, be at one end of the contact member distal from the contact surface. This can make it easier to separate the point of attachment from the point of electrical connection. Preferably the contacts in the connector part are end-point contacts—i.e. providing an end-point contact surface adapted to engage with a corresponding contact on a distal end of a conductor rather than an extended surface contact such as an annular ring. Preferably the connector part comprises end-point contacts for both the live and neutral poles.

To take advantage of the contacts being matched to a mains power supply cable, it is preferable that the thickness of a silver layer at least on the contact surface of the live electrical contact is selected depending on the current to be supplied by the power supply cable. For example, the thickness of the silver layer may be selected from one or more of: (i) 1-5 μm; (ii) 5-10 μm; (iii) 10-20 μm; (iv) 20-30 μm; (v) 30-40 μm; (vi) 40-50 μm; (vii) 50-100 μm; (viii) 100-200 μm; (ix) 200-300 μm; or (x) greater than 300 μm. The silver layer may be applied by plating or coating silver material onto the surface of a contact member, especially for thinner layers. However a thicker layer of silver e.g. 250-400 μm may be applied as a tip of material to provide an end-point contact surface. The electrical contacts may comprise a bi-metal contact member, e.g. a copper pin with a silver layer to provide a contact surface.

By a permanent attachment it will be understood that the electrical contacts cannot be removed from the respective conductors of the power supply cable without causing irreversible damage or destruction. Such permanent attachment is distinct from the usual attachment means provided, such as crimp-on connectors or “Faston” tab connectors, that are attached to the conductors of the power cable at one end and allow a leaf spring carrying one of the electrical contacts to be removably attached at the other end. Such non-permanent attachment means are typically provided so that the same power supply cable can be used with different cordless connectors, with the electrical contacts being added or removed as required during the manufacturing process. However a problem arising from a conventional non-permanent attachment is that electrical contacts which are not appropriate for the current rating of a certain power supply cable may be attached. Another problem is that the end of the power cable close to the non-permanent attachment has to be protected from being tugged, for example by wrapping it in a serpentine configuration underneath a power base unit carrying the connector part, so that forces on the cable do not inadvertently detach the conductors from the electrical contacts. It is an advantage of this aspect of the invention that a permanent attachment eliminates the risk of the conductors in the power supply cable being detached from the electrical contacts, so that the power supply cable can be led straight out from the connector part without a serpentine configuration. This can reduce the length of power supply cable that is required for an appliance and further reduce material costs.

The second aspect of the invention further extends to a cordless electrical appliance comprising an appliance unit separable from a base unit which supplies electrical power to the appliance unit when it is placed thereon by means of a cordless electrical connector, said connector being of the type which allows placement of the appliance unit on the base unit irrespective, or substantially irrespective, of their relative angular orientation, the cordless connector comprising a connector part in the appliance unit with electrical terminals that can be brought into engagement with a corresponding connector part as described above to make an electrical connection to the electrical contacts therein.

The various features discussed above in relation to the first aspect of the invention may equally be applied to a sub-assembly, connector part and/or appliance in accordance with the second aspect of the invention. Thus the permanent attachment between the electrical contacts and respective conductors in the power supply cable may be a resilient one, but preferably the contacts have a static attachment to the conductors. This can make it easier to protect the contacts using an overmolding. And while the permanent attachment of the electrical contacts to respective conductors in the power supply cable may be indirect, for example with a separate contact-mounting member or even a leaf spring welded or otherwise attached between them, preferably the contacts (or contact members thereof) are directly and permanently attached to the conductors in the power supply cable.

The electrical contacts may be permanently attached to respective conductors in the power supply cable by any suitable means. In one set of embodiments the contacts may, for example, be welded, soldered, or brazed to the conductors. The contacts may even be adhesively attached to the conductors. It is desirable to form an electrical contact or contact member from copper due to its superior electrical conductivity. However, there are two significant disadvantages to using copper material. Firstly, copper is very prone to oxidation. When attaching a copper contact or contact member to a copper conductor, there is a risk of copper oxide being formed at the attachment point. Copper oxide is a poor electrical conductor, and when it builds up at an interface it can lead to rapid deterioration and electrical failure. Any initial layer of copper oxide causes self-heating at the attachment point, resulting in further oxide build-up. Secondly, copper is a soft material and, although it can work harden, in its pure form it anneals to a crystalline state at relatively low temperatures. To prevent the build-up of an oxide layer, high pressure must be maintained when attaching two copper parts (e.g. a gas-tight joint). But the inherent softness of copper makes it unsuitable for maintaining the high pressure required. Accordingly it is common to use an alternative material, such as nickel-plated mild steel, for that part of a contact or contact member that is to be attached. The nickel plating provides resistance to oxidation at the attachment point while the steel provides mechanical strength across a range of temperatures.

In a preferred set of embodiments the contacts, or contact members thereof, are permanently attached to the conductors by mechanical deformation e.g. by crimping to form a gas-tight connection. Such a permanent connection, or any other means of permanent attachment, may then be protected by an integral molding e.g. a plastics ovennolding that covers the point of attachment. The overmolding can help to avoid oxidation at the attachment point when a copper member is attached to a copper conductor. In one set of embodiments the attachment point of the electrical contacts may share an integral molding with the power supply cable, for example with the plastic sheathing of the cable being molded around at least part of the conductors and a part of the contacts or contact members permanently attached thereto, while the contact surfaces are left exposed. Such a molded sub-assembly may then be incorporated into a connector part that provides a housing for the contacts, preferably preventing direct access to the contact surfaces. However, in at least some embodiments the power supply cable may be integrally molded with a connector part (or portion thereof) so that the integral molding comprises a single plastics part that houses the contacts, as is described above.

The Applicant has devised an improved way of permanently attaching a contact, or contact member thereof, to a conductor. Preferably the contact comprises a member having an internal bore for receiving the end of a conductor. Both the contact member and the conductor may be formed of copper. By applying a radial force to crimp the two parts together, the contact member deforms to provide a ring of material around the conductor. The internal bore is preferably crimped to form two, three or more protrusions projecting radially into the bore, to facilitate the axial spread of material when the member is deformed. A continuous ring of deformed material around the conductor can provide an increased surface pressure sufficient to form a gas-tight connection. The risk of copper oxidation is therefore reduced without the cost of adding a nickel-plated member. Furthermore, the necessary hoop stress in such an arrangement is quite low as compared to providing the equivalent pressure with a conventional F-crimp or open barrel attachment.

This feature is considered novel and inventive in its own right, regardless of whether the permanent attachment is overmolded, and thus when viewed from a further aspect the present invention provides a sub-assembly comprising an electrical conductor and an electrical contact for a connector part for supplying power to an independent appliance part in a cordless electrical appliance, wherein the electrical contact comprises a contact member provided with a contact surface at one end and an internal bore at the other end, the conductor being inserted into the bore and having a permanent gas-tight attachment to the contact member around a circumference of the conductor. This aspect of the invention may equally find use in attaching a contact to a conductor in a connector part that is provided in a cordless electrical appliance or control thereof, rather than in a base connector part. While the gas-tight attachment may be sufficient to avoid oxidation, especially when the electrical contact and/or conductor are made of copper the risk of oxidation may be further eliminated by preferably overmolding the attachment point with plastics material.

In one set of embodiments the live and neutral contacts may comprise a static connection, while the earth contact comprises a leaf spring. Preferably, at least the live and neutral contacts are housed by the integrally molded part. Although the earth contact could also be within the integrally molded housing, in a set of embodiments the earth contact projects from the integrally molded housing. The projecting earth contact may be connected by a leaf spring without complicating the molding operation, because the outside periphery of the housing can be accessible for shut-off features in the mold tool.

The static contacts discussed above may be ideally suited for engagement with the electrical terminal(s) of an appliance connector part that comprises a moveable contact member mounted on a switch lever, e.g. as is described in the Applicant's co-pending application(s) also claiming priority from GB1113780.9.

As mentioned earlier, an advantage of permanently attaching the electrical contacts (or contact members thereof) to the power supply cable in an integrated sub-assembly for a connector part is that the sub-assembly fixes the functionally important components of the connector while leaving freedom for the design and manufacture of the rest of the connector part. This means that there is flexibility in the choice of a housing for the connector part. The housing may be designed, for example, based on local safety standards relating to protection of the electrical contacts from outside interference. In addition, or alternatively, a different molding process may be used for the housing. Where an integral molding is used to protect the permanent attachment of the contacts to the conductors of the power supply cable, a separate housing that does not need to be formed by the same molding operation can make it easier to select appropriate plastics for different portions of the connector part. In particular it can be advantageous in certain countries to emboss or mold a company logo or other insignia on the housing. This can provide reassurance to the consumer in jurisdictions where low quality copies pose a risk. The separate housing also provides a practical route to providing moldings with colors to match the particular appliance, for example matching the power base unit.

Preferably the connector part comprises a housing for the electrical contacts that enables the electrical terminations of an appliance connector part to be brought into contact with the electrical contacts in the connector part irrespective, or substantially irrespective, of their relative angular orientation. The connector part may be manufactured by integrally molding the housing with the sub-assembly, or by attaching a separate housing to the sub-assembly.

The protective function of the contact housing is one that is important regardless of whether the housing is formed as part of the sub-assembly or provided separately. The Applicant has devised some novel features for the contact housing of a connector part that can assist in preventing water from forming a continuous wet bridge from the electrical contacts to the exterior according to any of the aspects of the invention defined above. Such features, which will be described below, can be particularly important when the contacts are static and/or directly attached to the conductors of the power supply cable, which means that the height of the connector part may be reduced as compared to conventional connector designs. The smaller the distance between an electrical contact and the housing that separates it from the outside environment, the greater the risk that water splashed onto the connector part might bridge across to the live contact and create an electrocution hazard. The minimum distance from the electrical contact(s) to the exterior of the housing is typically 3 mm.

In embodiments of the present invention the connector part, or its sub-assembly, comprises a contact housing that comprises an opening above a respective electrical contact to enable a corresponding electrical terminal to pass into the connector part and come into engagement with the electrical contact. Preferably the opening(s) are arranged such that electrical terminals can make an electrical connection with corresponding contacts in the connector part irrespective, or substantially irrespective, of their relative angular orientation. The contact housing may therefore provide for up to 360° connection.

In one set of embodiments the opening comprises a downwardly depending lip. This features helps to ensure that any water that runs into the opening and spans down to the contact below will form a droplet at the lip as the surface tension will not be great enough to maintain a wet bridge against the effect of gravity on a droplet e.g. at least 3 mm in size. This forces the droplet to tear away from the lip, which preferably runs circumferentially around the opening. Preferably the downwardly depending lip creates a dry zone in the housing that circumscribes the opening. This can prevent water from spreading continuously over any internal surfaces and reaching the electrical contact via an indirect route i.e. there is no path for electrical tracking. Instead, the circumferential dry zone provides a bridge across which electrical tracking cannot occur. This can be particularly important if the connector part is wetted with salt water to pass the moisture resistance test outlined in IEC Standard 60335-2-15, clause 15.102 for the safety of household and similar electrical appliances. These features may be applied to the openings for both the live and/or neutral contacts.

In one set of embodiments the opening extends circumferentially of the electrical contact to lead to a liquid collection surface inside the housing that is spaced away from the contact. Thus water that runs into the opening, or droplets that are formed, may be collected on this surface and kept separate from the contact. The collection surface may be provided with a drainage outlet. The drainage outlet may be arranged to direct water out of the housing. The opening associated with a collection surface may have an annular form. This feature may be particularly suitable for an annular opening for the neutral contact that enables an arc- or ring-shaped terminal to engage with the neutral contact.

Another feature that can be applied to either, or both, of the sets of embodiments described above is a liquid guiding surface connected to each opening. The opening in the housing may be connected to a continuous surface that extends radially away from the opening, for example a surface on the underside of the housing. Thus any liquid that enters the opening will run along the surface, moving radially away from the electrical contact below the opening This feature may be provided instead of, or in addition to, a downwardly depending lip or a circumferentially spaced collection surface. For example, an opening may be provided with a lip to encourage droplets to form and also be connected to an undersurface extending away radially so that any liquid which does not form into droplets runs away from the contact. At the same time as being guided radially, such liquid may also be guided circumferentially to a collection and drainage point inside the housing.

In all of the various aspects and embodiments of the invention described above, the electrical contacts may comprise a live contact and a neutral contact, and optionally also an earth contact. The live and/or neutral contact surfaces may be carried by a contact member that takes the form of an upstanding pin, for example foamed from copper. The contacts surfaces, or at least the live contact surface, may be coated, plated or otherwise provided with a surface layer of silver to improve conductivity and integrity at the point of electrical connection. Where the connector part is designed for use with an appliance part and control that always intends to make and break the electrical connection at the live contact, then the neutral contact may not be provided with a silver layer on its contact surface, or at least a thinner layer of silver.

### BRIEF DESCRIPTION OF THE DRAWINGS

Certain embodiments of the invention will now be described, by way of example only, with reference to the accompanying drawings in which:

FIG. 1 is a perspective view of a power base unit for a cordless electrical appliance including an electrical connector part according to a first embodiment;

FIG. 2 is partial cross-sectional view of the power base unit seen in FIG. 1;

FIG. 3 is an exploded close-up of the cross-sectional view of FIG. 2;

FIG. 4 is an exploded, perspective view of the molded connector part seen in FIGS. 1 to 3;

FIG. 5 is an exploded perspective view of an electrical connector part according to a second embodiment;

FIG. 6a is a close-up of the connector part seen in FIG. 5 and FIG. 6b is a cross-sectional view taken through the close-up of FIG. 6a; and

FIG. 7a shows the attachment of a conductor to a contact member and FIG. 7b shows detail for the contact member.

### DETAILED DESCRIPTION OF THE INVENTION

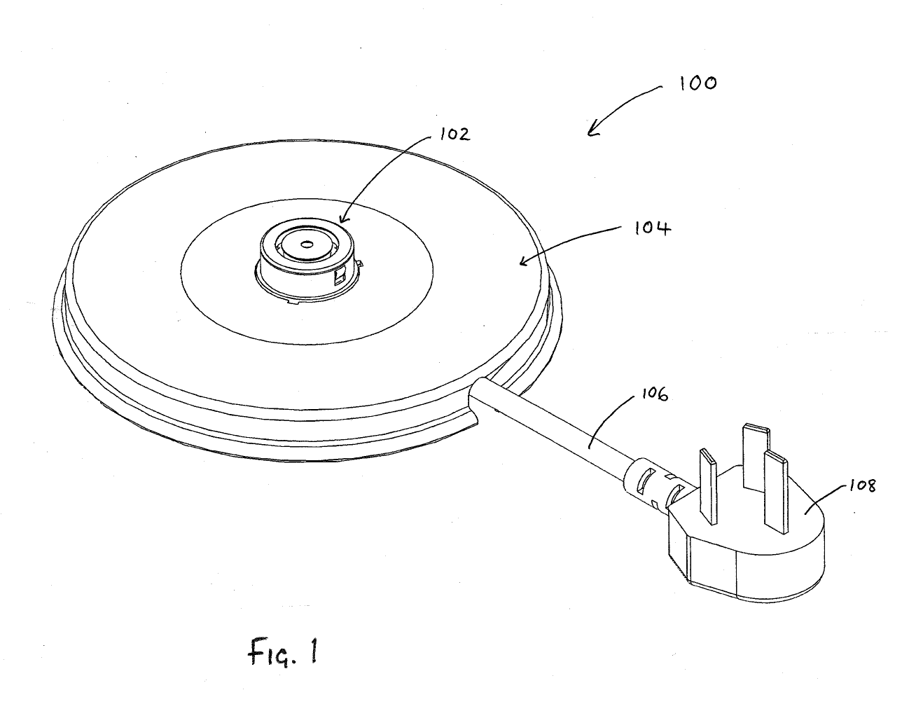

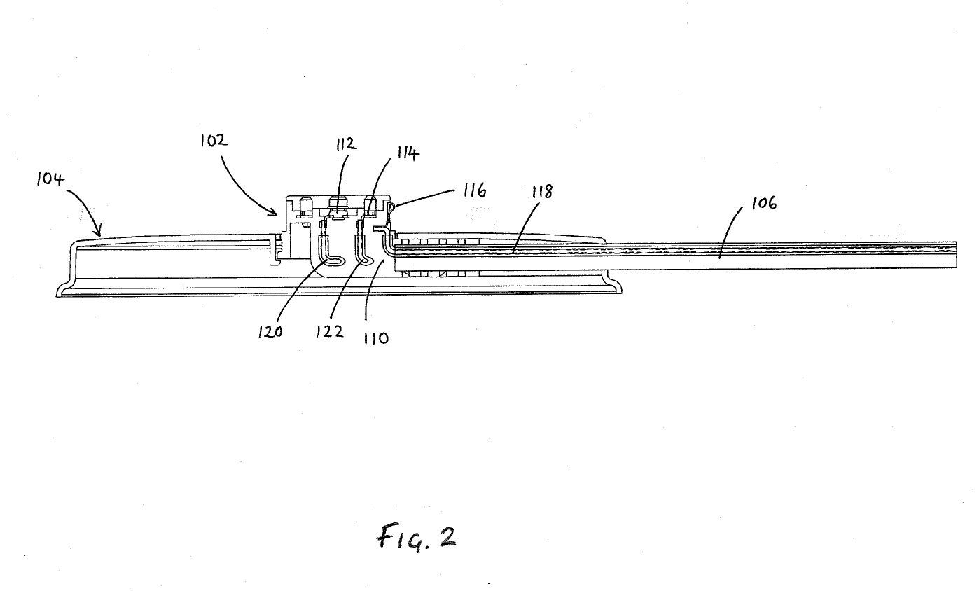

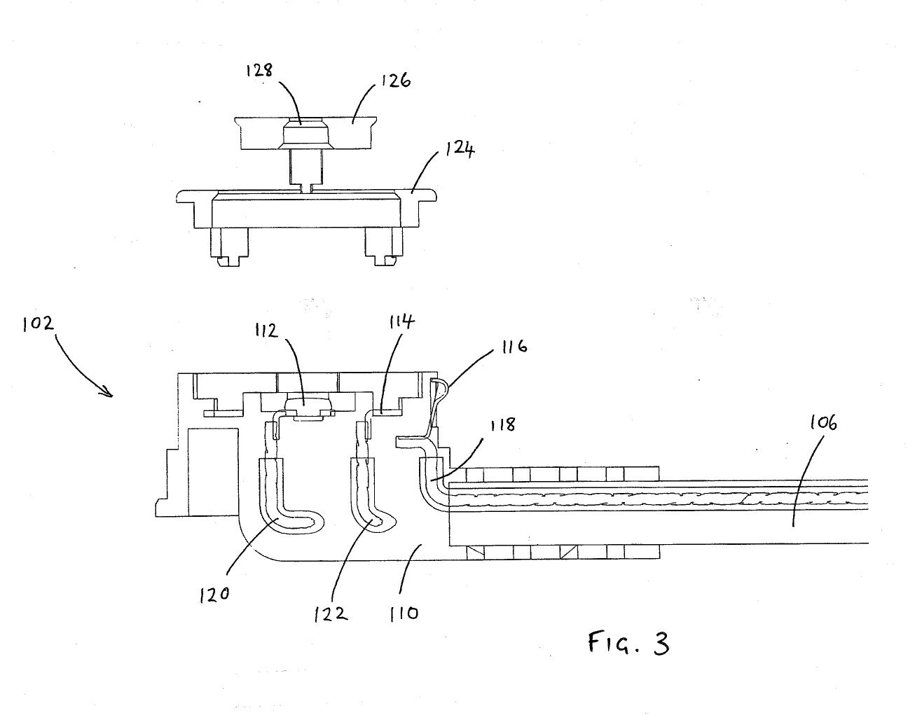

There is seen in FIG. 1 a power base unit 100 for a cordless electrical appliance (not shown). The power base unit 100 comprises an upstanding base electrical connector part 102 fitted through a central recess in a base stand 104. The connector part 102 can be engaged with a corresponding connector part or control provided on the underside of an appliance at any relative angular orientation, i.e. it is a so-called 360° connector part. A power supply cord 106 passes out from the underside of the base stand 104 and is provided with a mains plug 108 at its distal end. From the cross-sectional views of FIGS. 2 and 3 it can be seen that the power supply cord 106 is terminated at its opposite end by a molding 110 that is shared with the base connector part 102.

The components making up the base connector part 102 will be described with reference to FIGS. 2 to 4. The main part of the base connector 102 is provided by the molding 110 that is integrated with the power cord 106. Inside this molding 110 there is housed a centrally arranged contact 112 for the live pin of the appliance connector part, a concentrically arranged contact 114 for the neutral ring, and projecting from the side of the molding 110 there is an earth tab 116 which is sprung so as to be resiliently biased against the earth ring of the appliance connector part or control when the appliance is placed down on the base stand 104. The earth tab 116 comprises a leaf spring connected directly to the earth lead 118 of the power cord 106. Unlike a conventional three pole cordless connector, it can be seen that the live and neutral contacts 112, 114 are also connected directly to the corresponding leads 120, 122 of the power cord 106. No intervening leaf springs or blade-type e.g. “Faston” tab connectors are provided. The connection between each contact 112, 114, 116 and the corresponding lead 120, 122, 118 of the power cord 106 is protected inside the molding 110 from the ingress of water or foreign bodies.

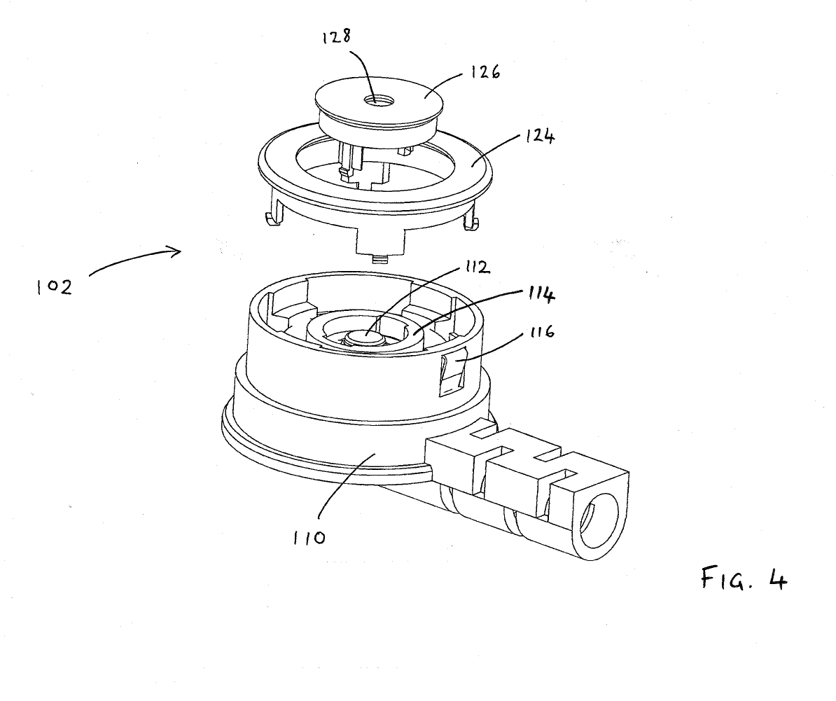

It can be seen from FIGS. 3 and 4 that some components of the base connector part 102 are not part of the integral molding 110. An outer cover ring 124 is snap fitted on top of the molding 110 to cover the neutral contact 114. An inner cover 126 is snap fitted inside the ring 124 to protect the live contact 112 and provide a central aperture 128 that only allows access by the live pin of the appliance connector part or control. While the covers 124, 126 are provided as separate parts in this embodiment so as to simplify the molding process, they could of course be integrally molded in one form or another with the rest of the base connector 102.

As the contacts 112, 114, 116 are permanently attached to the respective conducting leads 120, 122, 118 of the power cord 106 and covered by the integral molding 110, there is no risk of the electrical connection being loosened if the cord 106 is pulled. It is therefore seen e.g. in FIG. 2 that the cord 106 is led straight from the base connector part 102 to pass out from the underside of the base stand 104. Whereas a power cord attached to a conventional connector is typically wound in a serpentine configuration beneath a base stand so that any tugging on the cord can be absorbed without its leads pulling off the leaf spring connectors, the straight power cord 106 may therefore be made shorter than is conventional, saving materials usage and cost.

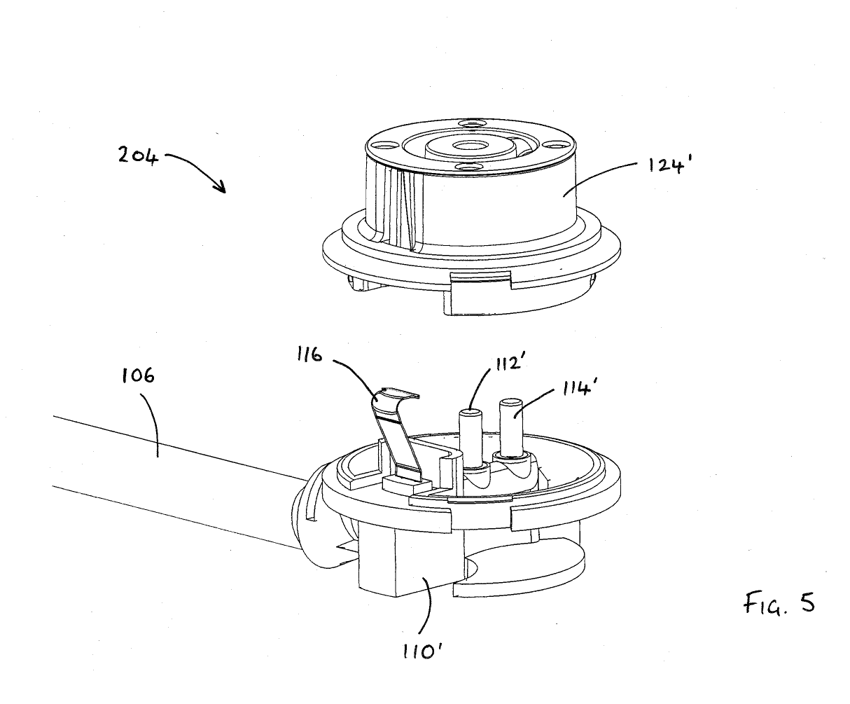

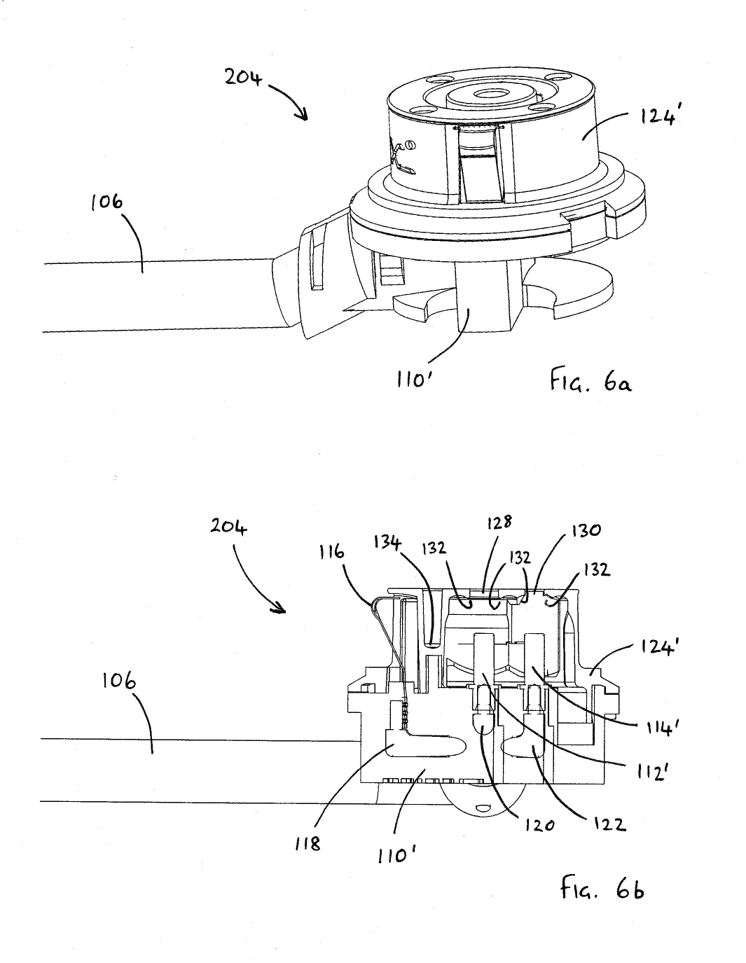

FIGS. 5 and 6 show details of another base connector part 204 that could be used with the base stand 104 seen in FIG. 1. As before, the power cord 106 contains an earth lead 118, live lead 120 and neutral lead 122 with the terminal end of each lead 118, 120, 122 connected directly to the respective earth contact spring 116, live contact 112′, and neutral contact 114′ in the base connector part 204.

In this embodiment the live and neutral contacts 112′, 114′ each take the form of an upstanding contact member or pin with an end-point contact surface.

From the cross-sectional view of FIG. 6b it is clearly seen that an integral molding 110′ again encapsulates the end of the power cord 106 and the connection between its leads 118, 120, 122 and the respective contacts 116, 112′, 114′. However, in this embodiment the integral molding 110′ is a sub-assembly that does not house the contacts. Instead, the molding 110′ is covered by a separate housing 124′ for the contact pins 112′, 114′. The housing 124′ may snap fit onto the sub-assembly comprising the molding 110′ and power cord 106.

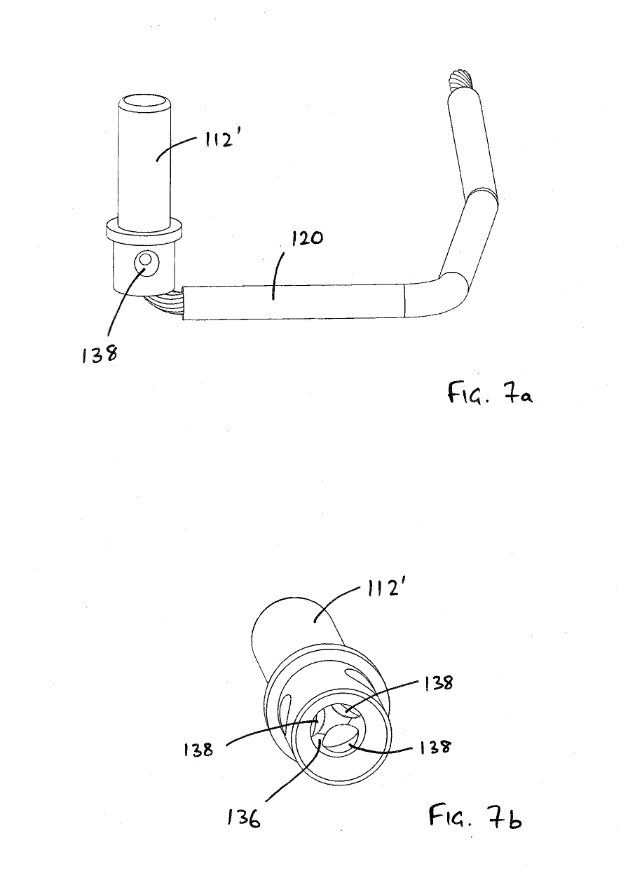

It will be appreciated that the amount of material used for the integral molding 110′ may be minimized as it does not act to house the contacts 112′, 114′, 116 but only to protect the point of permanent attachment to the power cord 106. The housing 124′ can be molded as a separate piece. The integral molding 110′ is formed around the proximal end of the power cable 106 after the adjacent ends of the contact pins 112′, 114′ and earth spring 116 have been permanently attached to the ends of respective leads 120, 122, 118, for example by a mechanical deformation operation such as crimping. FIGS. 7a and 7b illustrate how the end of a conductor lead 120 can be inserted into a bore 136 formed in one end of a contact pin 112′ and then crimped to form a gas-tight connection. As is seen in FIG. 7b, the crimping operation may provide the bore 136 with a number of protrusions 138 extending radially inwardly towards the inserted lead 120. There can be seen three such protrusions 138 formed as indentations around the circumference of the pin 112′. When the pin 112′ is crimped onto the lead 120, these protrusions of deformed material faun a continuous ring of material surrounding the lead 120. While crimping the leads 120, 122, 118 to the contacts pins 112′, 114′ and earth spring 116 can provide a gas-tight attachment that prevents oxidation occurring at the connection point, the subsequent overmolding 110′ can protect from other external influences and eliminate any leakage that could result in air and/or moisture reaching the connection and affecting its electrical integrity.

The exposed contact surfaces of the live and neutral pins 112′, 114′ may be covered with a layer of silver. In some connectors only the live contact 112′ may have a silvered surface, if this is the only contact intended to make or break electrical connection. However the neutral contact 114′ may also have a surface layer of silver. Whereas conventional contacts are typically tipped with a thick (e.g. at least 300 μm) layer of silver, to ensure safety even for high currents, a connector designed for a mains power supply e.g. of 220 V or 240 V may use a surface layer of silver that it only around 10-100 μm thick Such thin layers can be achieved by silver plating.

Referring back to FIG. 6b, various features are molded into the housing 124′ so as to ensure that the electrical connector part 204 is not hazardous even if it comes into contact with water. The housing 124′ is provided with two openings in its upper surface, a central aperture 128 through which a live terminal (e.g., a pin) can pass to contact the end-point surface of the live contact pin 112′ and a concentric ring aperture 130 through which a neutral terminal (e.g., a ring) can pass to contact the end-point surface of the neutral contact pin 114′. The side surface of the housing 124′ is also provided with an opening for the earth contact 116, which comprises a leaf spring as previously described.

As can be seen from FIG. 6b, both the aperture 128 for the live pin 112′ and the aperture 130 for the neutral pin 114′ are provided with a downwardly depending lip 132. For the central aperture 128 the lip 132 circumscribes the entire opening, so that any liquid that runs into the opening 128 will tend to form a drop rather than maintaining a wet bridge that spans down to the live pin 112′. Once the housing 124′ is fitted over the earth tab 116, its orientation is fixed so that only a portion of the ring-shaped opening 130 is above the neutral pin 114′. At least this portion of the opening 130 (seen on the right hand side in FIG. 6b) is provided with a downwardly depending lip 132. The opening 130 above the neutral pin 114′ extends circumferentially to a liquid collection surface 134 that is spaced away from the contacts 112′, 114′. It can also be seen that radially outward of each opening 128, 130 the downwardly depending lip 132 is part of a continuous surface that can guide liquid radially away from the contact pins 112′, 114′. Even though the connector part 204 may have a relatively low profile, e.g. with only a 3 mm separation between the contact surfaces and the exterior of the housing 124′, these features all contribute towards ensuring that the electrical pins 112′, 114′ are separated from the upper surface of the housing 124′ by a dry zone that prevents electrical tracking, e.g. so that a human finger touching the housing 124′ does not receive an electric shock even if the connector part 204 is wet.

It will be appreciated that the connector parts described herein may find use in connecting electrical power to many different kinds of cordless liquid heating apparatus, including electric kettles and water boilers, hot water dispensers, beverage makers and steam irons.

1. A connector part for supplying power to an independent appliance part in a cordless electrical appliance, the connector parts being separable such that an electrical connection between the electrical terminations of the appliance connector part and corresponding electrical contacts in the connector part is made when the independent connector parts are brought together, irrespective or substantially irrespective of their relative angular orientation, wherein the connector part comprises a sub-assembly comprising a mains power supply cable and the electrical contacts, in which the electrical contacts are permanently attached to respective conductors in the mains power supply cable.

2. The connector part as claimed in claim 1, wherein the mains power supply cable is rated for a voltage of at least 90 V, and preferably at least 100 V, 110 V, 120 V, 220 V, 230 V or 240 V.

3. The connector part as claimed in claim 1, wherein the electrical contacts comprise live and neutral contacts.

4. The connector part as claimed in claim 1, wherein the electrical contacts comprise one or more of: a live contact surface covered with a layer of silver; and neutral contact surface covered with a layer of silver.

5. (canceled)

6. The connector part as claimed in claim 4, wherein the thickness of the silver layer(s) is selected depending on the current rating of the mains power supply cable.

7. The connector part as claimed in claim 4, wherein the thickness of the silver layer(s) is selected from one or more of: (i) 1-5 μm; (ii) 5-10 μm; (iii) 10-20 μm; (iv) 20-30 μm; (v) 30-40 μm; (vi) 40-50 μm; (vii) 50-100 μm; (viii) 100-200 μm; (ix) 200-300 μm; or (x) at least 300 μm.

8. The connector part as claimed in claim 1, wherein the electrical contacts each comprise a contact member carrying a contact surface, the contact members being directly attached to the respective conductors in the mains power supply cable.

9. (canceled)

10. The connector part as claimed claim 1, wherein the permanent attachment of the electrical contacts is formed by mechanical deformation.

11. The connector part as claimed in claim 10, wherein the electrical contact(s) comprises a member having an internal bore for receiving the end of a respective conductor and the member is radially crimped to form a gas-tight connection around a circumference of the conductor.

12. The connector part as claimed in claim 1, wherein the point of permanent attachment is protected by a plastics overmolding, for example an integral molding shared with a sheath of the mains power supply cable.

13. (canceled)

14. The connector part as claimed in claim 1, wherein the mains power supply cable is integrally molded with the sub-assembly and a housing for the contacts is provided separately from the sub-assembly.

15. The connector part as claimed in claim 1, comprising a contact housing that comprises an opening above a respective electrical contact to enable a corresponding electrical terminal to pass into the connector part and come into engagement with the electrical contact.

16-21. (canceled)

22. A method of manufacturing a connector part for supplying mains power to an independent appliance part in a cordless electrical appliance, the connector parts being separable such that an electrical connection between the electrical terminations of the appliance connector part and the corresponding electrical contacts in the connector part is made when the independent connector parts are brought together, the method comprising the steps of:
providing a mains power supply cable comprising current-carrying conductors;
making a sub-assembly by permanently attaching respective electrical contacts to the ends of the conductors; and
providing a housing for the electrical contacts that enables the electrical terminations of an appliance connector part to be brought into contact with the electrical contacts in the connector part irrespective, or substantially irrespective, of their relative angular orientation.

23. (canceled)

24. The method as claimed in claim 22, comprising the step of attaching a separate housing to the sub-assembly.

25. A cordless electrical appliance comprising an appliance unit separable from a base unit which supplies mains electrical power to the appliance unit when it is placed thereon by means of a cordless electrical connector, said connector being of the type which allows placement of the appliance unit on the base unit irrespective, or substantially irrespective, of their relative angular orientation, the cordless connector comprising a base connector part and a corresponding connector part in the appliance unit with electrical terminals that can be brought into engagement with the base connector part to make an electrical connection to electrical contacts therein, wherein the base connector part comprises a mains power supply cable and the electrical contacts are permanently attached to respective conductors in the mains power supply cable.

26. The appliance as claimed in claim 25, wherein the mains power supply cable is rated for a voltage of at least 90 V, and preferably at least 100 V, 110 V, 120 V, 220 V, 230 V or 240 V.

27. (canceled)

28. The appliance as claimed in claim 25, wherein the electrical contacts comprise one or more of: a live contact surface covered with a layer of silver; and a neutral contact surface covered with a layer of silver.

29. (canceled)

30. The appliance as claimed in claim 28, wherein the thickness of the silver layer(s) is selected depending on the current rating of the mains power supply cable.

31. The appliance as claimed in claim 30, wherein the thickness of the silver layer(s) is selected from one or more of: (i) 1-5 μm; (ii) 5-10 μm; (iii) 10-20 μm; (iv) 20-30 μm; (v) 30-40 μm; (vi) 40-50 μm; (vii) 50-100 μm; (viii) 100-200 μm; (ix) 200-300 μm; or (x) at least 300 μm.

32. The appliance as claimed in claim 25, wherein the mains power supply cable is led straight out from the base connector part to the exterior of the base unit.

33-53. (canceled)
